(19) United States
(12) Patent Application Publication
(10) Pub. No.: US 2020/0296253 A1
(43) Pub. Date: Sep. 17, 2020

(54) INFORMATION PROCESSING APPARATUS, INFORMATION PROCESSING SYSTEM, AND NON-TRANSITORY COMPUTER READABLE MEDIUM STORING INFORMATION PROCESSING PROGRAM FOR VERIFYING AN ELECTRONIC SIGNATURE

(71) Applicant: FUJI XEROX CO., LTD., Tokyo (JP)

(72) Inventor: Takehiro ICHIKAWA, Kanagawa (JP)

(73) Assignee: FUJI XEROX CO., LTD., Tokyo (JP)

(21) Appl. No.: 16/505,700

(22) Filed: Jul. 8, 2019

(30) Foreign Application Priority Data
Mar. 11, 2019 (JP) 2019-044307

(51) Int. Cl. H04N 1/32; H04N 1/21; H04N 1/00

(52) U.S. Cl. CPC H04N 1/32283; H04N 1/00424; H04N 1/2191; H04N 1/32304

(57) ABSTRACT

An information processing apparatus includes a calculation unit that calculates a hash value of an original image represented by electronic information to which an electronic signature is added in advance, and a storage unit that stores image information representing the original image and the hash value calculated by the calculation unit in association with the electronic information.

### CROSS-REFERENCE TO RELATED APPLICATIONS

This application is based on and claims priority under 35 USC 119 from Japanese Patent Application No. 2019-044307 filed Mar. 11, 2019.

### BACKGROUND

### (i) Technical Field

The present invention relates to an information processing apparatus, an information processing system, and a non-transitory computer readable medium storing an information processing program.

### (ii) Related Art

JP2007-087322A proposes a workflow system, a server apparatus, a processing method, and a program capable of performing processing as a workflow process even in a case where an electronic form to be processed in a workflow is printed. More specifically, a workflow system, which includes screen formation data for forming an electronic form input screen and performs predetermined processing based on an electronic form in a case where input information is input from the input screen, is proposed. The workflow system includes paper form management means for generating paper layout information in a case where the input screen based on the screen formation data is formed in a paper form, print processing means for printing the input screen as a paper form based on the paper layout information together with an identification ID for identifying the electronic form, an image input device for inputting an image of a handwritten paper form, and paper flow processing means for extracting writing information from an image of an input paper form. The extracted writing information is converted into electronic writing information, and the electronic writing information is input to an electronic form corresponding to an identification ID.

Further, in JP2014-535216A, in a case where a user as a signer receives a hardcopy (for example, paper) document to be signed, the signer captures an image of the document to be signed using a camera of a mobile device. In this regard, a technique of allowing the signer to import the captured image to an electronic signature service for at least one of signing by another user, storing, or transmitting, is proposed.

### SUMMARY

In a case where the imported image is transmitted and received to and from a user who is not registered in the electronic signature service, when the imported image is printed on paper, the electronic signature may not be verified. Aspects of non-limiting embodiments of the present disclosure relate to an information processing apparatus, an information processing system, and a non-transitory computer readable medium storing an information processing program capable of verifying an electronic signature even in a case where there is a user who is not registered in the electronic signature service.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a calculation unit that calculates a hash value of an original image represented by electronic information to which an electronic signature is added in advance; and a storage unit that stores image information representing the original image and the hash value calculated by the calculation unit in association with the electronic information.

### BRIEF DESCRIPTION OF THE DRAWINGS

Exemplary embodiment(s) of the present invention will be described in detail based on the following figures, wherein:

FIG. 1 is a diagram illustrating a schematic configuration of an information processing system according to an exemplary embodiment;

FIG. 2 is a block diagram illustrating a main configuration of an electrical system of an image forming apparatus according to the exemplary embodiment;

FIG. 3 is a block diagram illustrating a main configuration of an electrical system of each of an information processing terminal and a cloud server according to the exemplary embodiment;

FIG. 4 is a functional block diagram illustrating a detailed functional configuration of a signature management service provided by the cloud server of the information processing system according to the exemplary embodiment;

FIG. 5 is a diagram illustrating an example of information stored in a document management DB;

FIG. 6 is a diagram illustrating an example of resource information stored in a resource management DB;

FIG. 7 is a diagram for explaining a use example of the signature management service in a case where an electronic signature is added;

FIG. 8 is a diagram illustrating an example of a document registration screen;

FIG. 9 is a diagram illustrating how electronic information to which an electronic signature is added is delivered to a third party and another company user as a third party who is not registered in a cloud service and does not have an account is allowed to verify the electronic signature;

FIG. 10 is a flowchart illustrating an example of a flow of processing performed by the information processing terminal in a case where a user operates the information processing terminal to use the signature management service provided by the cloud server of the information processing system according to the exemplary embodiment;

FIG. 11 is a diagram illustrating an example of a screen for generating an image with a two-dimensional barcode;

FIG. 12 is a flowchart illustrating an example of a flow of processing performed by an authentication service provided by the cloud server of the information processing system according to the exemplary embodiment;

FIG. 13 is a flowchart illustrating an example of a flow of processing performed by the signature management service in a case where a user uses the signature management service provided by the cloud server of the information processing system according to the exemplary embodiment;

FIG. 14 is a sequence diagram for explaining processing performed in the information processing system according to the exemplary embodiment;

FIG. 15 is a diagram illustrating a way of requesting the signature management service to perform verification by reading a two-dimensional barcode using a camera or the like of a mobile terminal;

FIG. 16 is a flowchart illustrating an example of processing performed by a mobile terminal of the information processing system according to the exemplary embodiment in a case of verifying whether or not a received document with signature verification location information is a specified correct document;

FIG. 17 is a flowchart illustrating an example of a flow of processing performed by the cloud server of the information processing system according to the exemplary embodiment in a case where the mobile terminal accesses, using a URL indicated by a two-dimensional barcode, the signature management service provided by the cloud server;

FIG. 18 is a diagram illustrating a way in which signing and sealing is performed by another user as a third party on a predetermined area of paper, on which an image representing a document with signature verification location information is formed, and the signed and sealed paper is returned to a registered user by post or like;

FIG. 19 is a diagram illustrating away in which a document obtained by reading and computerizing the signed and sealed paper by the image forming apparatus is registered in the signature management service;

FIG. 20 is a flowchart illustrating an example of a flow of processing performed by the image forming apparatus of the information processing system according to the exemplary embodiment in a case where the document obtained by reading and computerizing the signed and sealed paper is registered in the signature management service; and

FIG. 21 is a flowchart illustrating an example of a flow of processing performed by the cloud server in a case where the signature management service receives the document obtained by reading and computerizing the signed and sealed paper by the image forming apparatus.

### DETAILED DESCRIPTION

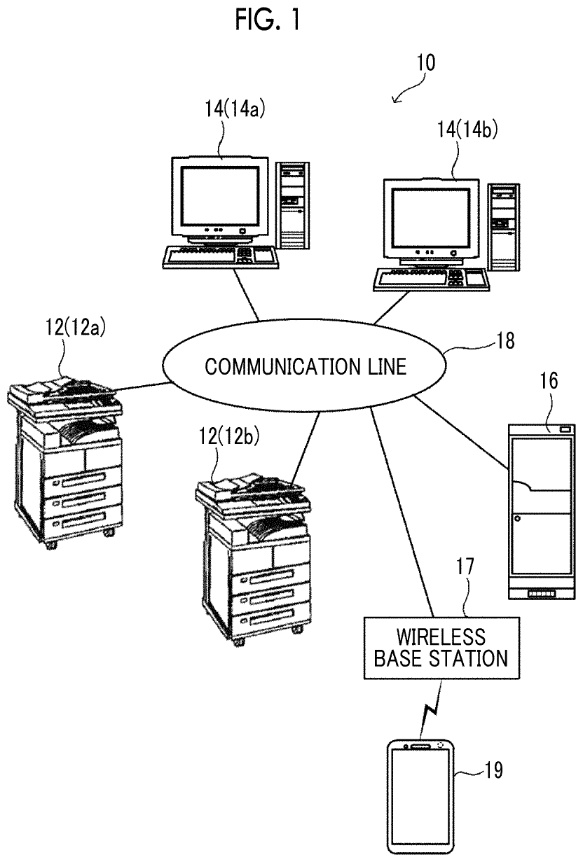

Hereinafter, an example of an exemplary embodiment will be described in detail with reference to the accompanying drawings. In the exemplary embodiment, an information processing system in which a plurality of image forming apparatuses, a plurality of information processing terminals, a wireless base station 17, and a cloud server are connected to each other via a communication line such as a network will be described as an example. FIG. 1 is a diagram illustrating a schematic configuration of an information processing system 10 according to the exemplary embodiment.

As illustrated in FIG. 1, the information processing system 10 according to the exemplary embodiment includes a plurality of image forming apparatuses 12a, 12b, a plurality of information processing terminals 14a, 14b, a wireless base station 17, and a cloud server 16. In a case where there is no need to distinguish the image forming apparatuses 12a, 12b, and the information processing terminals 14a, 14b, alphabets at the end of the numerals may be omitted. Further, in the exemplary embodiment, an example in which the plurality of image forming apparatuses 12a, 12b, and information processing terminals 14a, 14b, . . . are included will be described. On the other hand, at least one image forming apparatus 12 and at least one information processing terminal 14 may be included. Further, the image forming apparatus 12 corresponds to an image generation apparatus, the information processing terminal 14 corresponds to a terminal apparatus, and the cloud server 16 corresponds to an information processing apparatus.

The image forming apparatus 12, the information processing terminal 14, the wireless base station 17, and the cloud server 16 are connected to each other via a communication line 18 such as a local area network (LAN), a wide area network (WAN), the Internet, or an intranet. Thus, various data can be transmitted and received between the image forming apparatus 12, the information processing terminal 14, the wireless base station 17, and the cloud server 16 via the communication line 18. Further, a mobile terminal 19 is wirelessly connected to the wireless base station 17, and thus various data can be transmitted and received between the mobile terminal 19 and each apparatus.

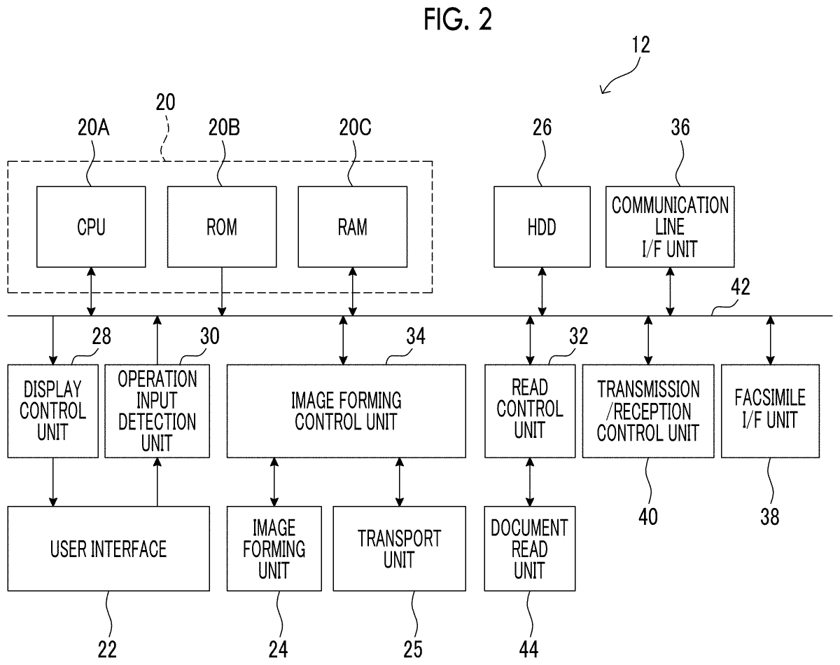

FIG. 2 is a block diagram illustrating a main configuration of an electrical system of the image forming apparatus 12 according to the exemplary embodiment.

As illustrated in FIG. 2, the image forming apparatus 12 according to the exemplary embodiment includes a control unit 20 including a central processing unit (CPU) 20A, a read only memory (ROM) 20B, and a random access memory (RAM) 20C. The CPU 20A controls the entire operation of the image forming apparatus 12. The RAM 20C is used as a work area or the like when the CPU 20A executes various programs. The ROM 20B stores various control programs and various parameters in advance. In the image forming apparatus 12, the components of the control unit 20 are electrically connected to each other via a system bus 42.

On the other hand, the image forming apparatus 12 according to the exemplary embodiment includes a hard disk drive (HDD) 26 that stores various data such as user information, setting parameters, and defect information, application programs, and the like. Further, the image forming apparatus 12 includes a display control unit 28 that is connected to a user interface 22 and controls display of various operation screens on a display of the user interface 22. Further, the image forming apparatus 12 includes an operation input detection unit 30 that is connected to the user interface 22 and detects an operation instruction which is input via the user interface 22. In the image forming apparatus 12, the HDD 26, the display control unit 28, and the operation input detection unit 30 are electrically connected to the system bus 42. In the image forming apparatus 12 according to the exemplary embodiment, the HDD 26 is used as a memory unit. On the other hand, the present disclosure is not limited thereto, and a non-volatile memory unit such as a flash memory may be used.

Further, the image forming apparatus 12 according to the exemplary embodiment includes a read control unit 32, which controls a read operation of an optical image by a document read unit 44 and a document transport operation by a document transport unit, and an image forming control unit 34, which controls image forming processing by an image forming unit 24 and transport of paper to the image forming unit 24 by a transport unit 25. Further, the image forming apparatus 12 includes a communication line interface (I/F) unit 36 that is connected to the communication line 18 and transmits and receives communication data to and from other external apparatuses such as the cloud server 16 connected to the communication line 18. Further, the image forming apparatus includes a facsimile interface (I/F) unit 38 that is connected to a telephone line (not illustrated) and transmits and receives facsimile data to and from a facsimile machine connected to the telephone line. Further, the image forming apparatus 12 includes a transmission/reception control unit 40 that controls transmission/reception of facsimile data via the facsimile I/F unit 38. In the image forming apparatus 12, the transmission/reception control unit 40, the read control unit 32, the image forming control unit 34, the communication line I/F unit 36, the facsimile I/F unit 38, and a log collection unit are electrically connected to the system bus 42.

With the configuration, in the image forming apparatus 12 according to the exemplary embodiment, the CPU 20A accesses each of the RAM 20C, the ROM 20B, and the HDD 26. Further, in the image forming apparatus 12, the CPU 20A controls display of information such as operation screens and various messages on a display 22A of the user interface 22 via the display control unit 28. Further, in the image forming apparatus 12, the CPU 20A controls operations of the document read unit 44 and the document transport unit via the read control unit 32. Further, in the image forming apparatus 12, the CPU 20A controls operations of the image forming unit 24 and the transport unit via the image forming control unit 34, and controls transmission and reception of communication data via the communication line I/F unit 36. Further, in the image forming apparatus 12, the CPU 20A controls transmission/reception of facsimile data via the facsimile I/F unit 38 by the transmission/reception control unit 40. Further, in the image forming apparatus 12, the CPU 20A recognizes operation contents of the user interface 22 based on operation information detected by the operation input detection unit 30, and executes various controls based on the operation contents.

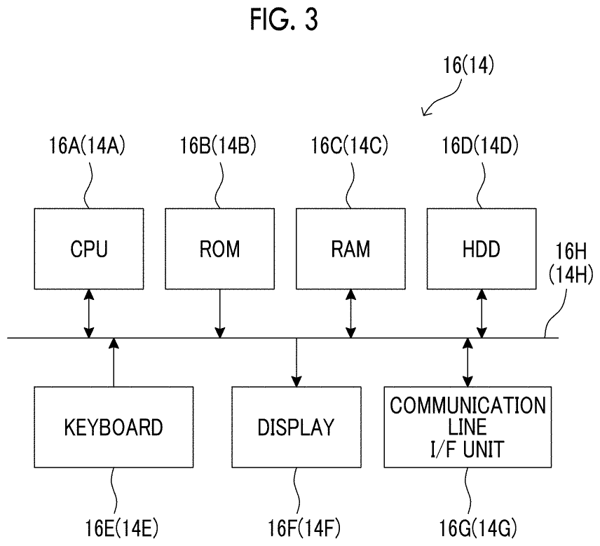

Next, a main configuration of an electric system of each of the information processing terminal 14 and the cloud server 16 according to the exemplary embodiment will be described. FIG. 3 is a block diagram illustrating a main configuration of an electrical system of each of the information processing terminal 14 and the cloud server 16 according to the exemplary embodiment. The information processing terminal 14 and the cloud server 16 are basically configured with general computers. Thus, in this description, the cloud server 16 will be representatively described.

As illustrated in FIG. 3, the cloud server 16 according to the exemplary embodiment includes a CPU 16A, a ROM 16B, a RAM 16C, an HDD 16D, a keyboard 16E, a display 16F, and a communication line interface (I/F) unit 16G. The CPU 16A controls the entire operation of the cloud server 16. The ROM 16B stores various control programs and various parameters in advance. The RAM 16C is used as a work area or the like when the CPU 16A executes various programs. The HDD 16D stores various data, application programs, and the like. The keyboard 16E is used to input various information. The display 16F is used to display various information. The communication line I/F unit 16G is connected to the communication line 18, and transmits and receives various data to and from other apparatuses connected to the communication line 18. The units of the cloud server 16 are electrically connected to each other by a system bus 16H. In the cloud server 16 according to the exemplary embodiment, the HDD 16D is used as a memory unit. On the other hand, the present disclosure is not limited thereto, and a non-volatile memory unit such as a flash memory may be used.

With the configuration, in the cloud server 16 according to the exemplary embodiment, the CPU 16A accesses each of the ROM 16B, the RAM 16C, and the HDD 16D, acquires various data via the keyboard 16E, and displays various information on the display 16F. Further, in the cloud server 16, the CPU 16A controls transmission and reception of communication data via the communication line I/F unit 16G.

Similar to the information processing terminal 14 and the cloud server 16, the mobile terminal 19 is basically configured with a computer including a CPU, a ROM, a RAM, and the like, and thus a detailed description thereof will be omitted.

In the information processing system 10 with the above-described configuration, the information processing terminal 14, the image forming apparatus 12, and the mobile terminal 19 can use a cloud service provided by the cloud server 16. As an example of the cloud service, in the exemplary embodiment, an example in which the cloud server 16 provides a signature management service and an authentication service as an example will be described. In the exemplary embodiment, an example in which the single cloud server 16 provides the signature management service and the authentication service as a cloud service will be described. On the other hand, the services may be respectively provided from different cloud servers 16.

In the signature management service, a hash value of electronic information is calculated, signature information encrypted using a private key is added to the original electronic information, as an electronic signature, and the calculated hash value is stored in a database or the like. In addition, in a case of performing signature verification, the signature verification is performed by decrypting the signature information added to the electronic information using a public key and comparing whether the hash value of the electronic information stored in the database or the like and the decrypted hash value are identical. As the electronic information, at least one of document information created by a document creation application program or the like or image information obtained by reading an image by the image forming apparatus 12 or the like is used.

On the other hand, in the authentication service, authentication is performed in a case where a cloud service such as a signature management service is provided. For example, a user is registered in advance, and user identification information (hereinafter, referred to as a user ID) and a password are set and stored in a database or the like. In a case of using a cloud service such as a signature management service, authentication is performed as to whether or not the user is a registered user.

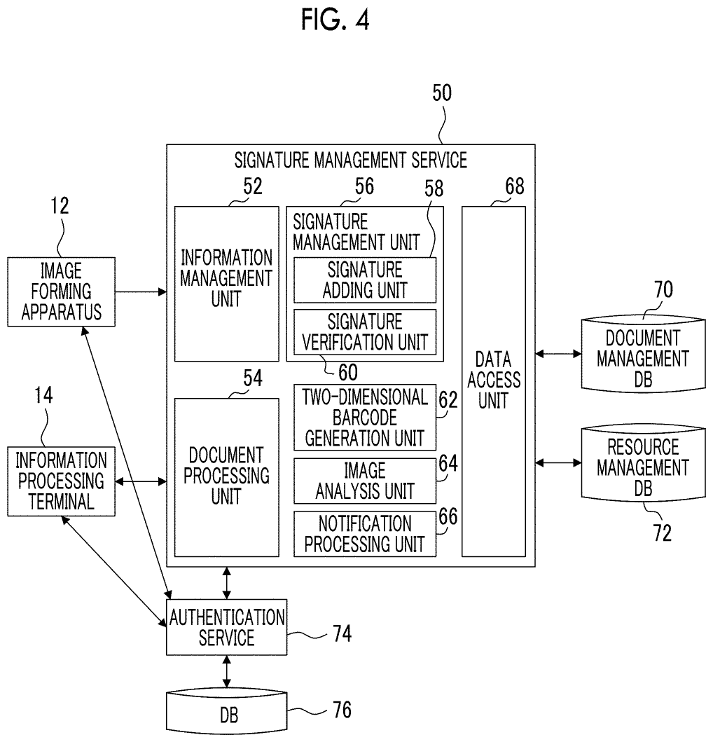

FIG. 4 is a functional block diagram illustrating a detailed functional configuration of a signature management service provided by the cloud server 16 of the information processing system 10 according to the exemplary embodiment.

In a case where the image forming apparatus 12 and the information processing terminal 14 access the cloud server 16, a signature management service 50 may be used in cooperation with an authentication service 74.

The signature management service 50 has functions of an information management unit 52, a document processing unit 54, a signature management unit 56, a two-dimensional barcode generation unit 62, an image analysis unit 64, a notification processing unit 66, and a data access unit 68.

The information management unit 52 manages transmission and reception of information to and from the information processing terminal 14, the image forming apparatus 12, and the authentication service 74.

The document processing unit 54 controls exchange of information between each unit so as to process the electronic information (for example, document information or image information) which is input. Further, the document processing unit 54 accesses a document management database (hereinafter, a database is referred to as DB) 70 and a resource management DB 72 via the data access unit 68, and reads and writes resource identification information (hereinafter, referred to as a resource ID), a user ID, a hash value, image information, and the like. Further, in a case of delivering the electronic information stored in the document management DB 70 to the information processing terminal 14 or the image forming apparatus 12, the document processing unit 54 stores the target electronic information in a shared area which is shared with a third party such as a file server.

The signature management unit 56 has functions of a signature adding unit 58 that adds an electronic signature and a signature verification unit 60 that verifies the electronic signature.

When electronic information is uploaded from a client such as the information processing terminal 14 or the image forming apparatus 12, the signature adding unit 58 adds an electronic signature using a private key of a user. In the exemplary embodiment, the electronic signature is added using a public key encryption method as an example. Specifically, the signature adding unit 58 calculates a hash value of the electronic information, adds signature information encrypted using a private key to the electronic information, as an electronic signature, and stores the calculated hash value in the document management DB 70. In addition, the signature adding unit 58 stores the calculated hash value in the resource management DB 72 in association with a resource ID, an uploaded user ID, and the like.

Further, the signature verification unit 60 verifies the electronic signature added to the electronic information. Specifically, the signature verification is performed by decrypting the signature information added to the electronic information using a public key and comparing whether the hash value, which is stored in the resource management DB 72 in association with the electronic information stored in the document management DB 70, and the decrypted hash value are identical.

The two-dimensional barcode generation unit 62 generates a two-dimensional barcode including a uniform resource locator (URL) for signature verification, as an example of position information.

The image analysis unit 64 performs processing of confirming identity of images by calculating a hash value of an image by analyzing the image of the electronic information and comparing the calculated hash value with a hash value stored in the resource management DB 72. Further, the image analysis unit 64 performs processing of updating the resource information stored in the resource management DB 72 using the calculated hash value of the image.

The notification processing unit 66 notifies various operation information and various information by transmitting an e-mail or the like to a related user. For example, in the exemplary embodiment, in a case where the document processing unit 54 stores target electronic information in a shared area which is shared with a third party such as a file server, the notification processing unit 66 notifies the storage location.

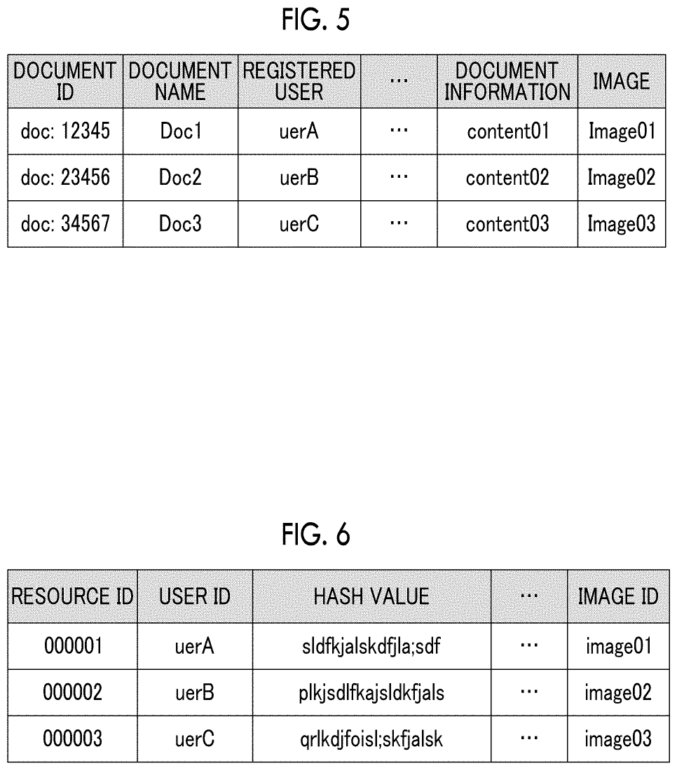

The document management DB 70 stores at least one of electronic information to which an electronic signature is added or electronic information to which an electronic signature is not added. For example, the document management DB 70 stores information as illustrated in FIG. 5. FIG. 5 illustrates an example in which a document ID, a document name, a registered user, document information, an image, and the like are stored in association with each other.

The resource management DB 72 stores a resource ID, an uploaded user ID of a user, a hash value, image information, and the like in association with each other. For example, the resource management DB 72 stores resource information as illustrated in FIG. 6. FIG. 6 illustrates an example in which a resource ID, a user ID, a hash value, image identification information (hereinafter, referred to as an image ID), and the like are stored in association with each other as resource information.

In addition, in a DB 76 accessed by the authentication service 74, a user ID, a password, and the like are stored, and the information is used so as to authenticate a user.

The image analysis unit 64 corresponds to a calculation unit, the document management DB 70 and the resource management DB 72 correspond to a storage unit, the two-dimensional barcode generation unit 62 corresponds to an adding unit, the notification processing unit 66 corresponds to a notification unit, and the signature verification unit 60 corresponds to a verification unit.

Here, a use example of a signature management service provided by the cloud server 16 of the information processing system 10 with the configuration will be described.

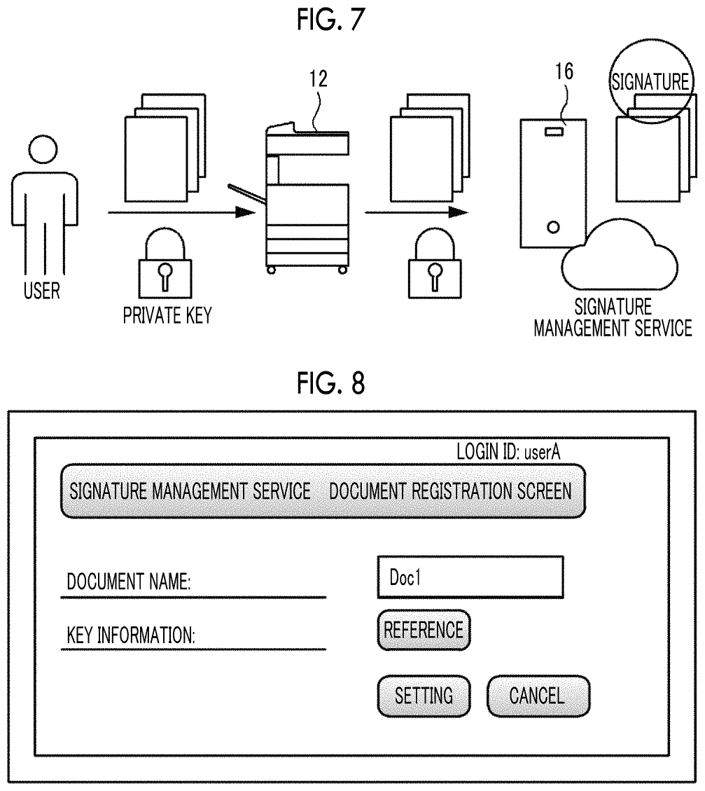

FIG. 7 is a diagram for explaining a use example of the signature management service 50 in a case where an electronic signature is added. FIG. 7 illustrates an example in which a paper document is read and computerized by the image forming apparatus 12 and an electronic signature is added to the document information.

First, the document read unit 44 of the image forming apparatus 12 is caused to read a paper document by a user, and a private key is set by a user. For example, a document registration screen illustrated in FIG. 8 is displayed on the user interface 22 of the image forming apparatus 12, and a document name, key information, and the like are set. Thereby, the paper document is computerized by the image forming apparatus 12, and the document converted into image information is transmitted to the signature management service 50 provided by the cloud server 16. In the signature management service 50, the signature adding unit 58 calculates a hash value of the image information, encrypts signature information using the private key set by a user, adds the encrypted signature information to the image information, as an electronic signature, and stores the calculated hash value in the document management DB 70. Further, the signature adding unit 58 stores the calculated hash value in the resource management DB 72 in association with a resource ID, an uploaded user ID, and the like. Thereby, the electronic information to which the electronic signature is added is accumulated in the document management DB 70.

In FIG. 7, although an example in which a paper document is computerized and an electronic signature is added to the document information is described, the present disclosure is not limited thereto. For example, an electronic signature may be added to document information created by a user using the information processing terminal 14 or the like, and the document information to which the electronic signature is added may be stored in the document management DB 70. That is, at least one of document information or image information is stored in the document management DB 70, as electronic information.

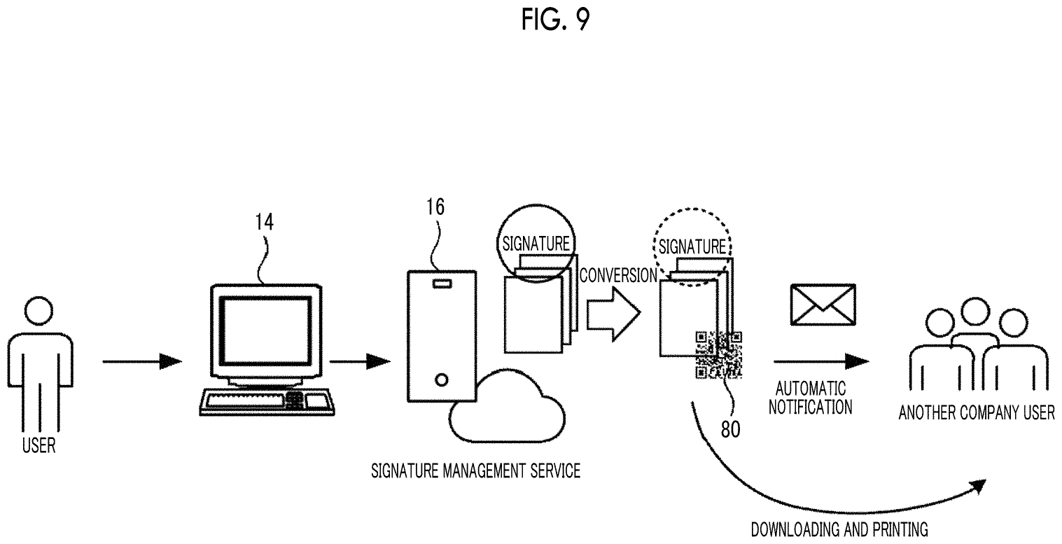

FIG. 9 is a diagram illustrating how electronic information to which an electronic signature is added is delivered to a third party and another company user as a third party who is not registered in a cloud service and does not have an account is allowed to verify the electronic signature.

The electronic information to which the electronic signature is added, which is stored in the document management DB 70, may be transmitted to another company user as a third party and requested to be signed and sealed. In this case, as illustrated in FIG. 9, even in a case where the electronic information to which the electronic signature is added is printed on paper, in order to make it possible to verify the electronic signature, the electronic signature is converted into a hash value of an image by adding a matrix-type two-dimensional barcode 80 representing a URL or the like for verifying the electronic signature to the electronic information, as location information, and the location information is stored in a shared area which is shared with a third party. The location information indicating a storage location is notified to another company user as a third party by an e-mail or the like.

Here, in a case where a user who is registered in the signature management service 50 delivers, as a document, the electronic information to which the electronic signature is added to another company user as a third party who is not registered in the signature management service 50 and does not have an account, specific processing performed by the information processing system 10 will be described.

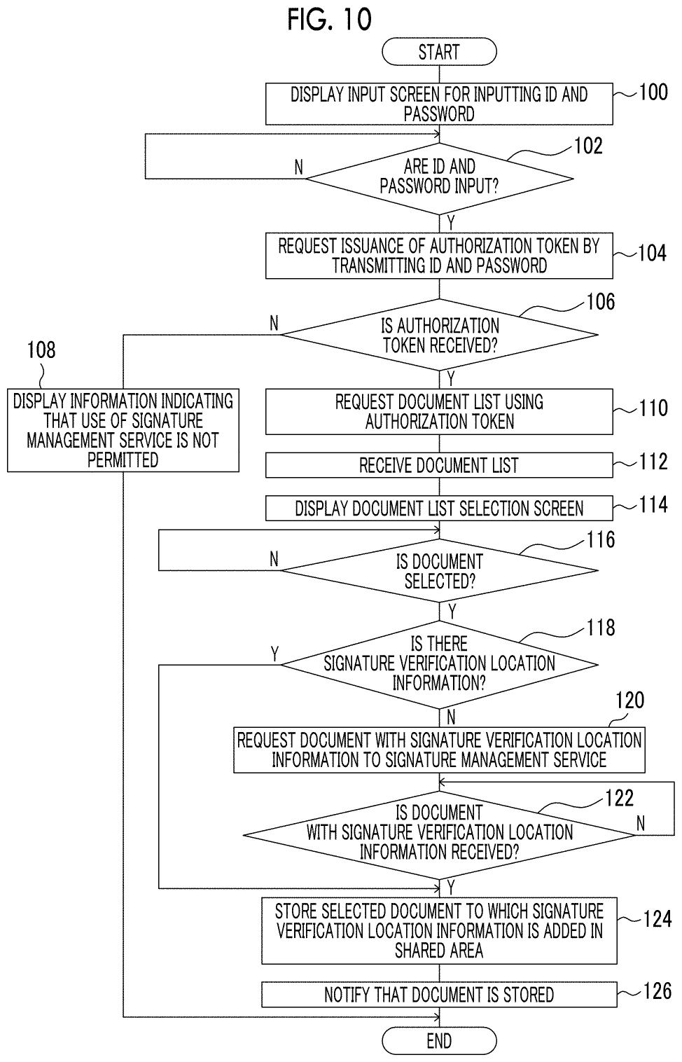

FIG. 10 is a flowchart illustrating an example of a flow of processing performed by the information processing terminal 14 in a case where a user operates the information processing terminal 14 to use the signature management service 50 provided by the cloud server 16 of the information processing system 10 according to the exemplary embodiment. The processing of FIG. 10 is started, for example, in a case where a user instructs starting of use of the signature management service 50 by operating the information processing terminal 14 or the like.

In step 100, the CPU 14A displays an input screen for inputting a user ID and a password, and the process proceeds to step 102.

In step 102, the CPU 14A determines whether or not a user ID and a password are input. The CPU 14A waits until the determination result is Yes, and the process proceeds to step 104. In a case where there is another instruction while waiting, the CPU 14A ends the process and executes instructed processing.

In step 104, the CPU 14A requests an issuance of an authorization token to use the signature management service by transmitting a user ID and a password to the authentication service 74, and the process proceeds to step 106.

In step 106, the CPU 14A determines whether or not an authorization token is received from the authentication service 74. In a case where the determination result is No, that is, in a case where the authentication service 74 does not permit use of the signature management service 50, the process proceeds to step 108.

In a case where the determination result is Yes, the process proceeds to step 110.

In step 108, the CPU 14A displays information indicating that use of the signature management service 50 is not permitted, on a display 14F, and a series of processing is ended.

On the other hand, in step 110, the CPU 14A requests a document list of the document management DB 70, that is, a list of the electronic information stored in the document management DB 70, from the signature management service 50, using the received authorization token, and the process proceeds to step 112.

In step 112, the CPU 14A receives a requested document list from the signature management service 50, and the process proceeds to step 114.

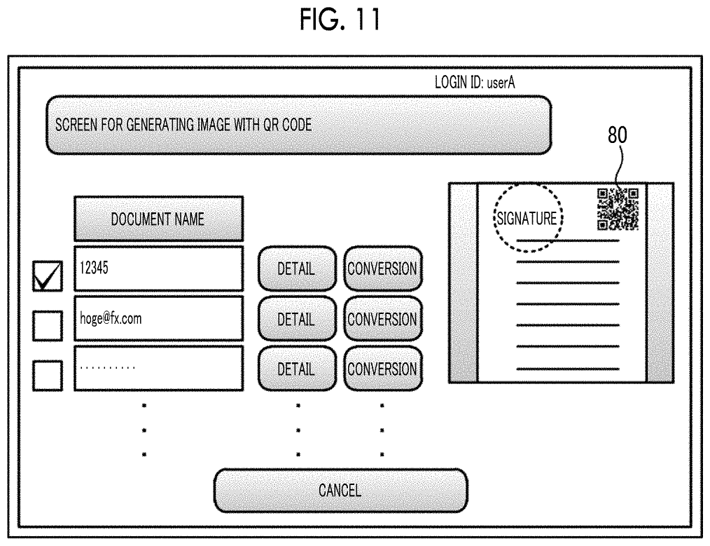

In step 114, the CPU 14A displays a document list selection screen for selecting a document to be delivered to a third party from the document list, and the process proceeds to step 116. For example, as a document list selection screen, an image generation screen with a two-dimensional barcode 80 as illustrated in FIG. 11 is displayed. The example of FIG. 11 illustrates an example in which electronic information corresponding to a document of which the document name is “12345” is selected and a preview image of the selected electronic information is displayed.

In step 116, the CPU 14A determines whether or not a document is selected. The CPU 14A waits until the determination result is Yes, and the process proceeds to step 118.

In step 118, the CPU 14A determines whether or not there is signature verification location information for signature verification. In this determination, it is determined whether or not location information such as a two-dimensional barcode representing location information such as a URL of a signature verification site is added to the selected document information. In a case where the determination result is No, the process proceeds to step 120, and in a case where the determination result is Yes, the process proceeds to step 124.

In step 120, the CPU 14A requests the signature management service 50 to add signature verification location information to the document information, and the process proceeds to step 122.

In step 122, the CPU 14A determines whether or not document information with signature verification location information, to which signature verification location information is added, is received.

The CPU 14A waits until the determination result is Yes, and the process proceeds to step 124.

In step 124, the CPU 14A stores the electronic information corresponding to the selected document, to which the signature verification location information is added, in a predetermined shared area that may be viewed by a third party, and the process proceeds to step 126. The shared area may be a shared area of a file server which is shared with a third party, may be an area in the document management DB 70, or may be another area.

In step 126, the CPU 14A notifies the information processing terminal 14 or the mobile terminal 19 of a third party that the electronic information is stored, and the series of processing is ended.

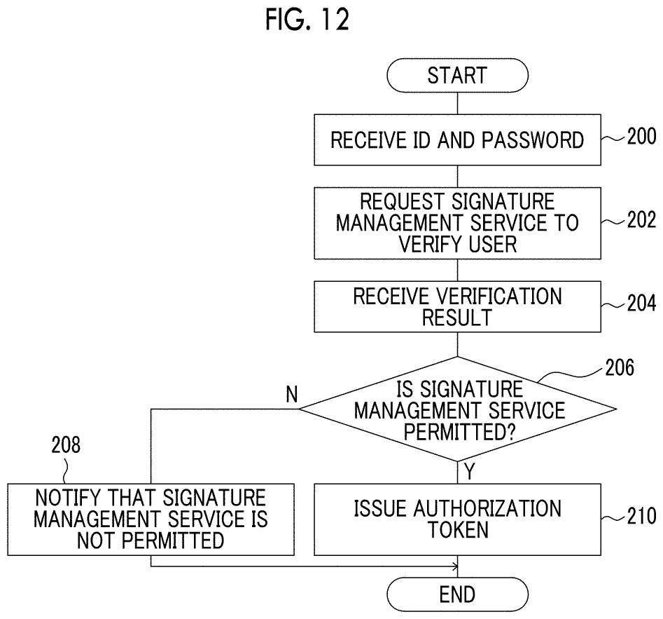

Next, authentication processing by the authentication service, which is performed in a case where a user operates the information processing terminal 14 to use the signature management service, will be described. FIG. 12 is a flowchart illustrating an example of a flow of processing performed by the authentication service 74 provided by the cloud server of the information processing system 10 according to the exemplary embodiment. The processing of FIG. 12 is started in a case where authentication is requested by a user via the information processing terminal 14 or the like. Specifically, the processing of FIG. 12 is started in a case where an issuance of an authorization token is requested in step 104 of FIG. 10.

In step 200, the authentication service 74 receives a user ID and a password from the information processing terminal 14 or the like, and the process proceeds to step 202.

In step 202, the authentication service 74 requests the signature management service 50 to verify whether a user corresponding to the received user ID and password is a registered user, and the process proceeds to step 204.

In step 204, the authentication service 74 receives a verification result from the signature management service 50, and the process proceeds to step 206.

In step 206, the authentication service 74 determines whether or not the received verification result indicates that the user is a registered user and the signature management service 50 is permitted for the registered user. In a case where the determination result is No, the process proceeds to step 208, and in a case where the determination result is Yes, the process proceeds to step 210.

In step 208, the authentication service 74 notifies the information processing terminal 14 that the signature management service 50 is not permitted, and a series of processing is ended.

On the other hand, in step 210, the authentication service 74 issues an authorization token to the information processing terminal 14, and the series of processing is ended. Thereby, the information processing terminal 14 is permitted to use the signature management service 50 using the authorization token.

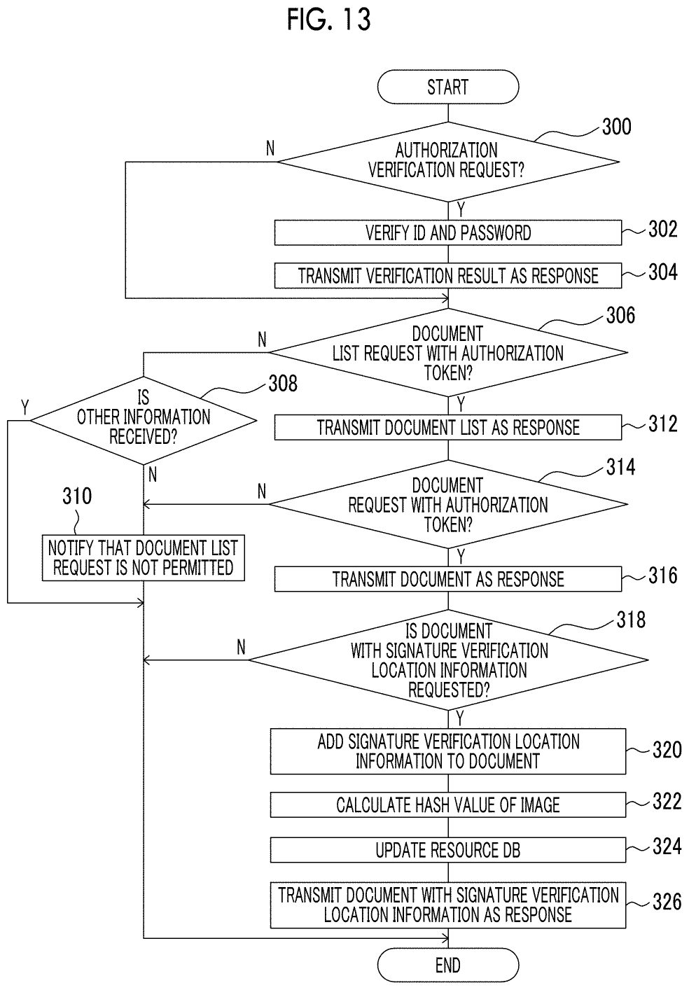

Next, in a case where a user operates the information processing terminal 14 or the like to use the signature management service 50, processing performed by the signature management service 50 will be described. FIG. 13 is a flowchart illustrating an example of a flow of processing performed by the signature management service 50 in a case where a user uses the signature management service 50 provided by the cloud server 16 of the information processing system 10 according to the exemplary embodiment. The processing of FIG. 13 is started in a case where information is received from the authentication service 74 or the information processing terminal 14.

In step 300, the information management unit 52 determines whether or not the received information is an authorization verification request from the authentication service 74. In a case where the determination result is Yes, the process proceeds to step 302, and in a case where the determination result is No, the process proceeds to step 306.

In step 302, the information management unit 52 performs verification of user registration by verifying the user ID and password received by the authentication service 74, and the process proceeds to step 304.

In step 304, the information management unit 52 transmits a verification result as a response to the authentication service 74, and the process proceeds to step 306.

In step 306, the information management unit 52 determines whether or not the received information is a document list request with an authorization token from the information processing terminal 14 or the like. In a case where the determination result is Yes, the process proceeds to step 312, and in a case where the determination result is No, the process proceeds to step 308.

In step 308, the information management unit 52 determines whether or not the received information is other information other than an authorization verification request and a document list request with an authorization token. In a case where the determination result is Yes, a series of processing is ended, and processing corresponding to the received other information is performed. In a case where the determination result is No, the process proceeds to step 310.

In step 310, the information management unit 52 notifies the request source that the document list request is not permitted, and the series of processing is ended.

On the other hand, in step 312, the document processing unit 54 acquires a requested document list from the document management DB 70 via the data access unit 68 and transmits the acquired document list as a response, and the process proceeds to step 314.

In step 314, the information management unit 52 determines whether or not a document request with an authorization token is performed. In a case where the determination result is No, the process proceeds to step 310, and in a case where the determination result is Yes, the process proceeds to step 316.

In step 316, the document processing unit 54 acquires electronic information corresponding to the requested document from the document management DB 70 via the data access unit 68 and transmits the acquired document as a response, and the process proceeds to step 318.

In step 318, it is determined whether or not a document with signature verification location information is requested. In a case where the determination result is No, the series of processing is ended, and in a case where the determination result is Yes, the process proceeds to step 320.

In step 320, the two-dimensional barcode generation unit 62 generates signature verification location information, and adds the generated signature verification location information to the document. Then, the process proceeds to step 322. For example, the two-dimensional barcode generation unit generates a two-dimensional barcode 80 including a URL for signature verification, as signature verification location information, and adds the two-dimensional barcode 80 to a document image.

In step 322, the image analysis unit 64 calculates a hash value of an image of the electronic information by analyzing the image of the electronic information, and the process proceeds to step 324. The hash value of the image is calculated by calculating a hash value of an image in a predetermined area which is not changed by post-processing other than an area which is signed and sealed in post-processing and an area to which the location information is added.

In step 324, the data access unit 68 updates a resource DB so as to store the calculated hash value in correspondence to the electronic information, and the process proceeds to step 326.

In step 326, the notification processing unit 66 transmits the document with signature verification location information, as a response, to the request source such as the information processing terminal 14 and the like, and the series of processing is ended.

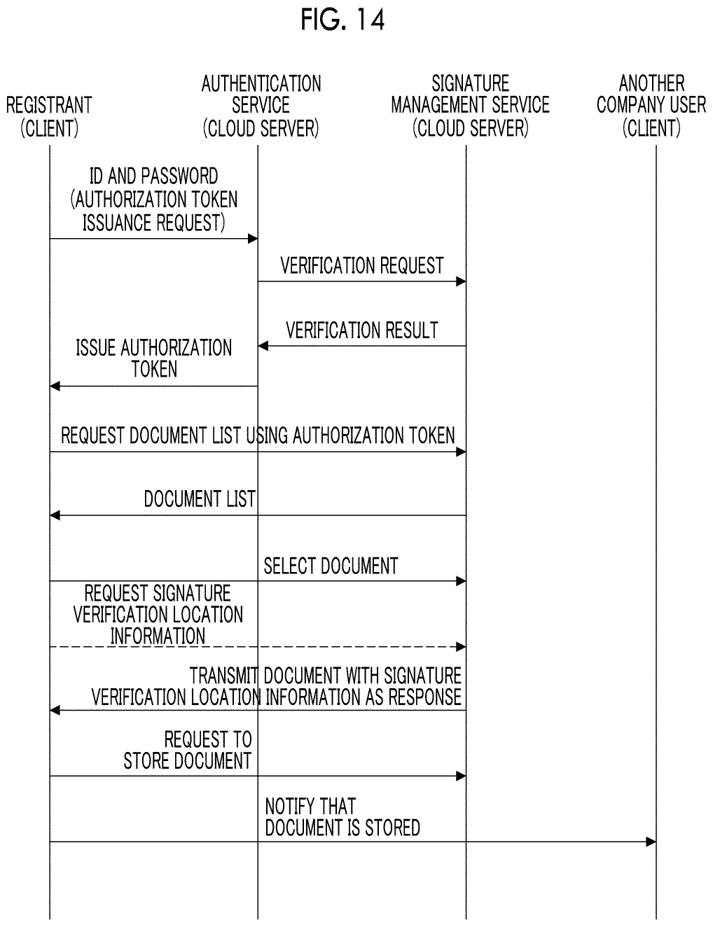

As described above, in the information processing system 10 according to the exemplary embodiment, as illustrated in FIG. 14, processing by each unit is performed.

That is, in processing of step 100 to step 104, in a case where a registered user (illustrated as a registrant in FIG. 14) inputs a user ID and a password by operating the information processing terminal 14 or the like, an authorization token issuance request is transmitted to the authentication service 74.

In processing of step 200 to step 202, in a case of receiving the authorization token issuance request, the authentication service 74 transmits a verification request of the user ID and the password to the signature management service 50.

In processing of step 300 to step 302, in a case of receiving the verification request from the authentication service 74, the signature management service 50 verifies whether a user corresponding to the user ID and the password is registered, and transmits a verification result to the authentication service 74.

In processing of step 204 to step 210, in a case where the verification result is received from the signature management service 50 and the received verification result indicates that the user is a registered user, the authentication service 74 issues an authorization token to the information processing terminal 14 or the like of the registrant. In a case where the received verification result indicates that the user is not a registered user, the authentication service 74 notifies the information processing terminal 14 that the signature management service 50 is not permitted.

Subsequently, in processing of step 106 to step 112, in a case where an authorization token is acquired, the registered user requests a document list to the signature management service 50 using the authorization token.

In processing of step 306 to step 312, the signature management service 50 confirms that the user is a registered user, using the authorization token, and transmits a requested document list as a response.

In processing of step 114 to step 122, the registered user selects a document from the document list acquired from the signature management service 50, and requests the document to the signature management service 50. At this time, in a case where signature verification location information is not added to the document, as illustrated by a dotted line in FIG. 14, signature verification location information is requested.

In processing of step 314 to step 326, the signature management service 50 transmits a document with signature verification location information as a response. In a case where signature verification location information is not added to the document and signature verification location information is requested from the registrant, the two-dimensional barcode generation unit 62 generates signature verification location information, adds the generated signature verification location information to the document, and transmits the document with signature verification location information to the registrant, as a response.

The registered user confirms the document with signature verification location information. In processing of step 124 to step 126, in a case where the registered user wants to transmit the document with signature verification location information to another user as a third party, the registered user stores the target document with signature verification location information in a shared area which is shared with the third party, and notifies the third party that the document is stored.

FIG. 10 to FIG. 14 illustrate an example in which the authentication service 74 transmits a verification request to the signature management service 50 in a case where a registered user requests an issuance of an authorization token to the authentication service 74. On the other hand, the present disclosure is not limited thereto. For example, in a case where a registered user requests an issuance of an authorization token to the authentication service 74, the authentication service 74 may issue an authorization token without requesting the signature management service 50 to verify the user, and in a case where a user requests the signature management service 50 using an authorization token, the signature management service 50 may request the authentication service 74 to verify the authorization token.

On the other hand, in a case where a notification is received from a registered user, another user as a third party confirms the shared area, and causes the image forming apparatus 12 or the like to form and output an image represented by the document with signature verification location information, on paper. On the output paper, a two-dimensional barcode 80 as signature verification location information is formed together with the image of the document.

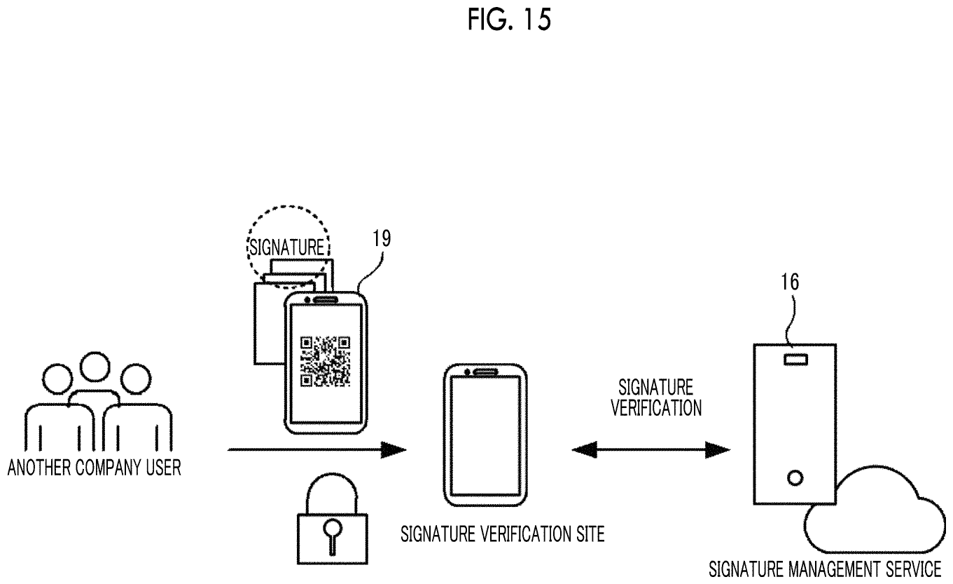

In a case of verifying whether or not the received document with signature verification location information is a correct document, as illustrated in FIG. 15, another user as a third party requests the signature management service 50 to perform verification by causing a camera of the mobile terminal 19 to read the two-dimensional barcode 80 formed on the paper.

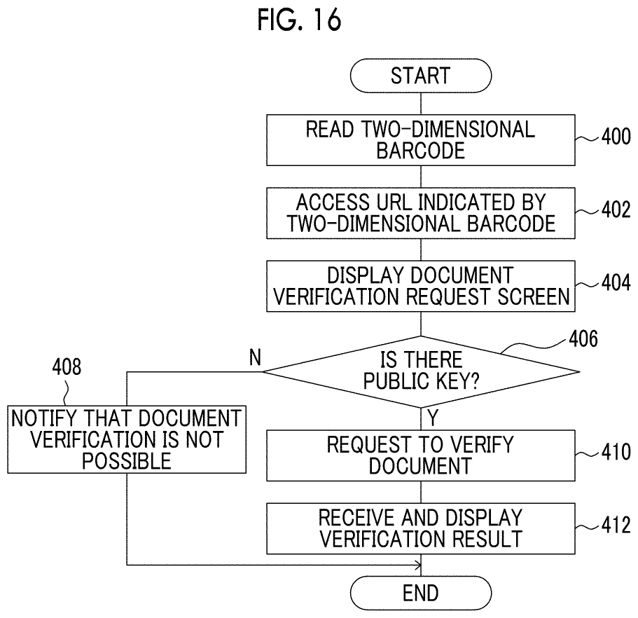

Here, an example of processing performed by the mobile terminal 19 in a case where a third party requests document verification as to whether or not the received document with signature verification location information is a specified correct document will be described. FIG. 16 is a flowchart illustrating an example of processing performed by the mobile terminal 19 of the information processing system 10 according to the exemplary embodiment in a case of verifying whether or not the received document with signature verification location information is a specified correct document. The processing of FIG. 16 is started, for example, in a case where an instruction for capturing a two-dimensional barcode 80 is performed by the mobile terminal 19.

In step 400, the mobile terminal 19 reads the two-dimensional barcode 80 formed on the paper, and the process proceeds to step 402.

In step 402, the mobile terminal 19 accesses a URL indicated by the two-dimensional barcode 80, and the process proceeds to step 404.

In step 404, the mobile terminal 19 displays a document verification request screen provided by the signature management service 50, and the process proceeds to step 406. As the document verification request screen to be displayed, for example, a screen for inputting a public key for specifying a verification target is displayed.

In step 406, the mobile terminal 19 determines whether or not there is a public key. In this determination, it is determined whether or not a public key is input on the document verification request screen. In a case where the determination result is No, the process proceeds to step 408, and in a case where the determination result is Yes, the process proceeds to step 410.

In step 408, the mobile terminal 19 notifies the third party who uses the mobile terminal 19 of a fact that the document verification is not possible by displaying the fact, and a series of processing is ended.

In step 410, the mobile terminal 19 requests the signature management service 50 to verify the document using a public key, and the process proceeds to step 412.

In step 412, the mobile terminal 19 receives a verification result from the signature management service 50 and displays the received verification result, and the series of processing is ended.

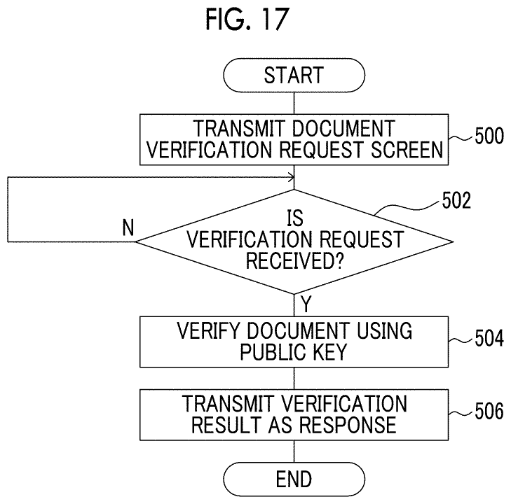

Next, an example of processing performed by the signature management service 50 in a case where the mobile terminal 19 accesses a URL indicated by the two-dimensional barcode 80 will be described. FIG. 17 is a flowchart illustrating an example of a flow of processing performed by the cloud server 16 of the information processing system 10 according to the exemplary embodiment in a case where the mobile terminal 19 accesses, using a URL indicated by the two-dimensional barcode 80, the signature management service 50 provided by the cloud server 16. In the exemplary embodiment, a case where a website designated by a URL including the two-dimensional barcode is a website provided by the signature management service 50 will be described as an example. In a case where a website designated by a URL including the two-dimensional barcode is a website provided by another cloud server or the like, not the signature management service 50 but another cloud server or another cloud service performs processing of FIG. 17.

In step 500, the signature verification unit 60 transmits a document verification request screen to the mobile terminal 19, and the process proceeds to step 502. Thereby, the document verification request screen is displayed on the mobile terminal 19 as described in step 404.

In step 502, the signature verification unit 60 determines whether or not a verification request is received. In this determination, it is determined whether or not a public key is input and a verification request is performed as described in step 406 to step 410. The signature verification unit 60 waits until the determination result is Yes, and the process proceeds to step 504.

In step 504, the signature verification unit 60 verifies, using the public key, whether or not the document with signature verification location information is a specified document, and the process proceeds to step 506. That is, the signature verification unit 60 verifies whether the document with the two-dimensional barcode captured by the mobile terminal 19 is a correct document. Specifically, in a case where the input public key is a correct public key, the signature verification unit 60 determines that the document with the two-dimensional barcode is a correct document.

In step 506, the notification processing unit 66 transmits, as a response, the verification result of step 504 to the mobile terminal 19 as a request source, and a series of processing is ended.

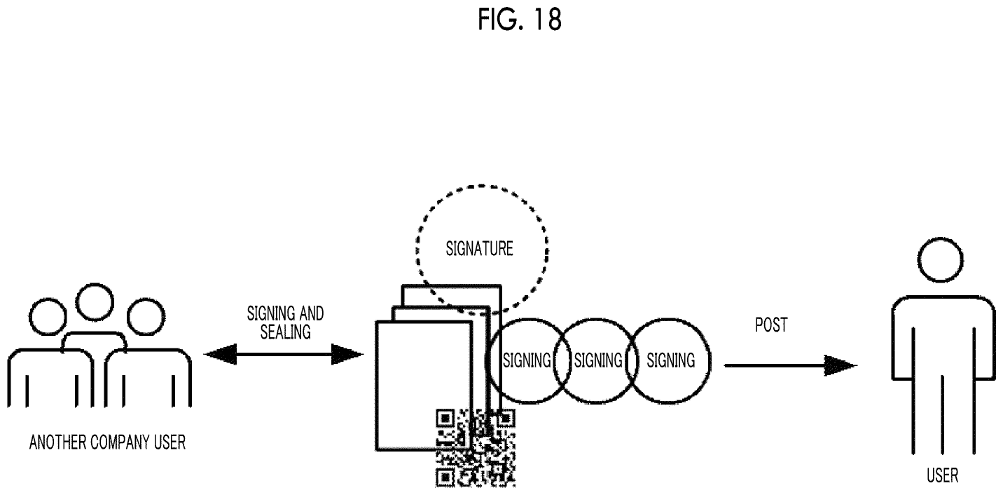

In addition, as illustrated in FIG. 18, signing and sealing is performed by another user as a third party on a predetermined area of the paper, on which the image representing the document with signature verification location information is formed, and the signed and sealed paper is returned to the registered user by post or like. The signed and sealed paper may be computerized by being read by the image forming apparatus 12 or the like, and may be transmitted to the registered user using an electronic mail or the like.

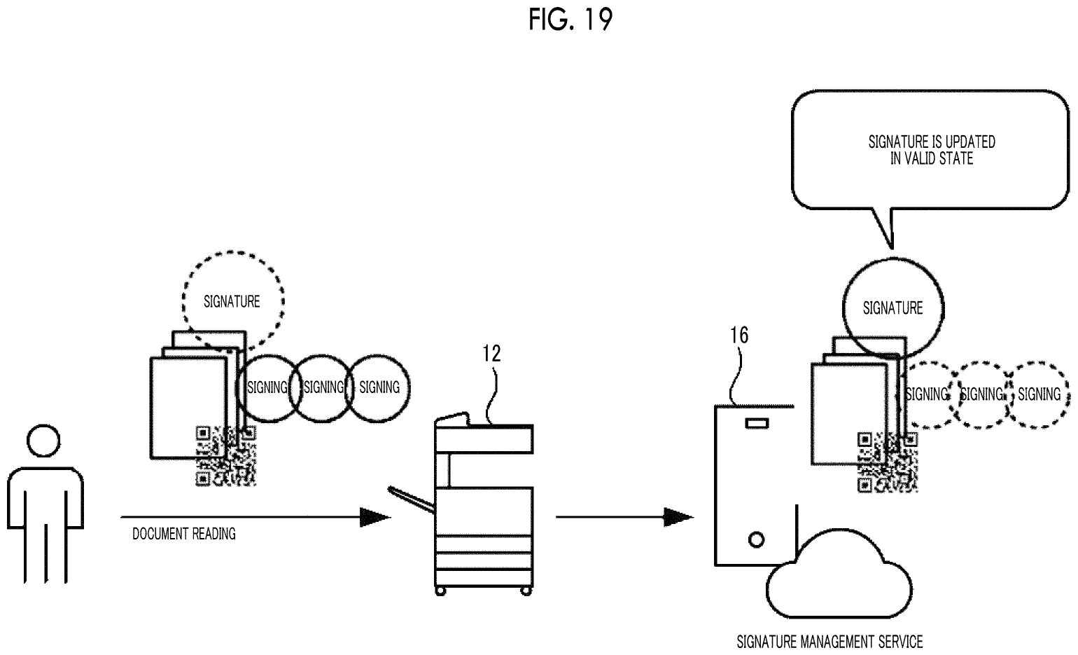

In a case where the registered user receives the signed and sealed paper by post or like, as illustrated in FIG. 19, the signed and sealed paper is computerized by being read by the image forming apparatus 12, and is registered in the signature management service 50.

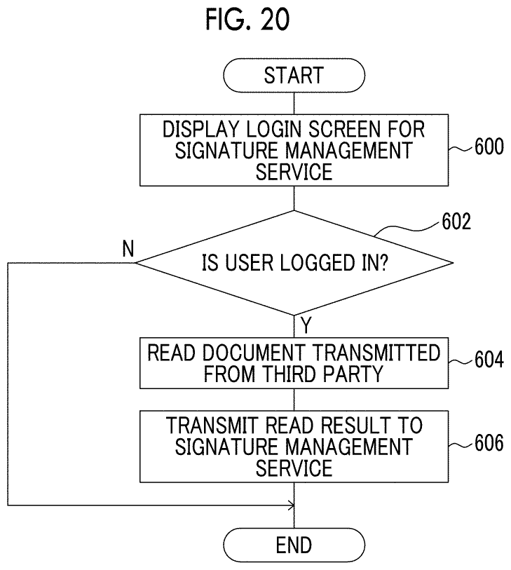

Here, a specific example of processing performed by the image forming apparatus 12 in a case where the document obtained by reading and computerizing the signed and sealed paper is registered in the signature management service 50 will be described. FIG. 20 is a flowchart illustrating an example of a flow of processing performed by the image forming apparatus 12 of the information processing system 10 according to the exemplary embodiment in a case where the document obtained by reading and computerizing the signed and sealed paper is registered in the signature management service 50. The processing of FIG. 20 is started in a case where an instruction for registering the document obtained by reading and computerizing the signed and sealed paper in the signature management service 50 is performed. The document obtained by reading and computerizing the signed and sealed paper corresponds to additional image information. In a case where the registered user receives the document obtained by computerizing the signed and sealed paper by an email or the like, the information processing terminal 14 performs processing other than step 604 of FIG. 20.

In step 600, the CPU 20A displays a login screen for the signature management service 50 on the user interface 22, and the process proceeds to step 602.

In step 602, the CPU 20A determines whether or not the registered user is logged in. In a case where the determination result is No, a series of processing is ended, and in a case where the determination result is Yes, the process proceeds to step 604.

In step 604, the CPU 20A controls the document read unit 44 to read the document transmitted from a third party, that is, the signed and sealed paper, and the process proceeds to step 606.

In step 606, the CPU 20A transmits the read result, which is the document obtained by reading and computerizing the signed and sealed paper, to the signature management service 50, and the series of processing is ended.

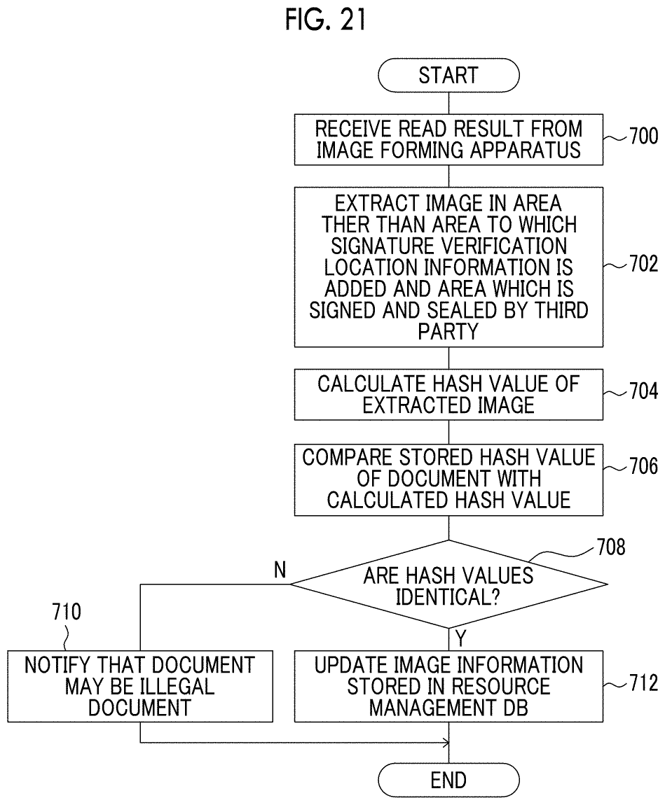

Next, an example of processing performed by the cloud server 16 in a case where the signature management service 50 receives the document obtained by reading and computerizing the signed and sealed paper by the image forming apparatus 12 will be described. FIG. 21 is a flowchart illustrating an example of a flow of processing performed by the cloud server 16 in a case where the signature management service 50 receives the document obtained by reading and computerizing the signed and sealed paper by the image forming apparatus 12. The processing of FIG. 21 is started in a case where the image forming apparatus 12 transmits the read result to the signature management service 50 in step 606.

In step 700, the document processing unit 54 receives the read result from the image forming apparatus 12, and the process proceeds to step 702. The processing of step 700 corresponds to processing by a reception unit.

In step 702, the image analysis unit 64 extracts an image in a predetermined area other than an area to which signature verification location information such as a two-dimensional barcode 80 is added and an area which is signed and sealed by a third party, and the process proceeds to step 704.

In step 704, the image analysis unit 64 calculates a hash value of the extracted image, and the process proceeds to step 706.

In step 706, the data access unit 68 acquires a hash value of the document stored in the resource management DB 72, and compares the acquired hash value with the calculated hash value. Then, the process proceeds to step 708.

In step 708, the image analysis unit 64 determines whether or not the acquired hash value and the calculated hash value are identical. In a case where the determination result is No, the process proceeds to step 710, and in a case where the determination result is Yes, the process proceeds to step 712.

In step 710, the notification processing unit 66 notifies the image forming apparatus 12 that the document obtained by reading and computerizing the signed and sealed paper may be an illegal document, and a series of processing is ended. Thereby, the image forming apparatus 12 displays that the document obtained by reading and computerizing the signed and sealed paper may be an illegal document, on the user interface 22.

In step 712, the data access unit 68 updates the image information stored in the resource management DB 72 with the image information which is read, and the series of processing is ended. The processing of step 712 corresponds to processing by an updating unit.

In the exemplary embodiment, although the two-dimensional barcode 80 including a URL or the like is described as an example of signature verification location information, the present disclosure is not limited thereto. For example, the URL itself may be added to the image. Alternatively, a one-dimensional barcode including a URL or the like may be added to the image.

In addition, although the processing performed by the cloud server 16 according to the exemplary embodiment is described as processing performed by software, the processing by the cloud server 16 may be performed by dedicated hardware or by a combination of software and hardware. The processing to be performed by the cloud server 16 may be distributed by being stored in a storage medium as a program.

The present invention is not limited to the exemplary embodiment, and various modifications may be made without departing from the spirit of the inventions.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing apparatus comprising a processor configured to execute:
a calculation unit that calculates a hash value of an original image represented by electronic information to which an electronic signature is added in advance; and
a storage circuit that stores image information representing the original image and the hash value calculated by the calculation unit in association with the electronic information,
wherein the calculation unit extracts an image in a predetermined area other than an area which is signed and sealed by a third party.

2. The information processing apparatus according to claim 1, wherein the processor is further configured to execute:
an adding unit that adds a location information image for verifying the electronic signature to the original image.

3. The information processing apparatus according to claim 2,
wherein the calculation unit calculates the hash value of a predetermined area which is not changed by post-processing, and
wherein the adding unit adds the location information image onto the original image.

4. The information processing apparatus according to claim 2,
wherein the adding unit adds the location information image independently from the original image.

5. The information processing apparatus according to claim 1, wherein the processor is further configured to execute:
a notification unit that notifies a terminal apparatus of a predetermined third party that the image information is stored in a predetermined shared area and the electronic information is stored in the shared area in a case where the electronic information of which the hash value is calculated by the calculation unit is delivered to the third party.

6. The information processing apparatus according to claim 2, wherein the processor is further configured to execute:
a notification unit that notifies a terminal apparatus of a predetermined third party that the image information is stored in a predetermined shared area and the electronic information is stored in the shared area in a case where the electronic information of which the hash value is calculated by the calculation unit is delivered to the third party.

7. The information processing apparatus according to claim 3, wherein the processor is further configured to execute:
a notification unit that notifies a terminal apparatus of a predetermined third party that the image information is stored in a predetermined shared area and the electronic information is stored in the shared area in a case where the electronic information of which the hash value is calculated by the calculation unit is delivered to the third party.

8. The information processing apparatus according to claim 4, wherein the processor is further configured to execute:
a notification unit that notifies a terminal apparatus of a predetermined third party that the image information is stored in a predetermined shared area and the electronic information is stored in the shared area in a case where the electronic information of which the hash value is calculated by the calculation unit is delivered to the third party.

9. The information processing apparatus according to claim 5, wherein the processor is further configured to execute:
a verification unit that receives a verification request of the electronic information stored in the shared area from the terminal apparatus and verifies whether the image information is correct image information.

10. The information processing apparatus according to claim 6, wherein the processor is further configured to execute:
a verification unit that receives a verification request of the electronic information stored in the shared area from the terminal apparatus and verifies whether the image information is correct image information.

11. The information processing apparatus according to claim 7, wherein the processor is further configured to execute:
a verification unit that receives a verification request of the electronic information stored in the shared area from the terminal apparatus and verifies whether the image information is correct image information.

12. The information processing apparatus according to claim 8, wherein the processor is further configured to execute:
a verification unit that receives a verification request of the electronic information stored in the shared area from the terminal apparatus and verifies whether the image information is correct image information.

13. The information processing apparatus according to claim 1, wherein the processor is further configured to execute:
a document processing unit that receives additional image information representing an additional image obtained by adding information to the original image represented by the image information stored in the storage circuit by a predetermined third party; and
an data access unit that causes the calculation unit to calculate a hash value of the additional image received by the document processing unit and updates the hash value stored in the storage circuit with the hash value of the additional image.

14. The information processing apparatus according to claim 2, wherein the processor is further configured to execute:
a document processing unit that receives additional image information representing an additional image obtained by adding information to the original image represented by the image information stored in the storage circuit by a predetermined third party; and
an data access unit that causes the calculation unit to calculate a hash value of the additional image received by the document processing unit and updates the hash value stored in the storage circuit with the hash value of the additional image.

15. The information processing apparatus according to claim 3, wherein the processor is further configured to execute:
a document processing unit that receives additional image information representing an additional image obtained by adding information to the original image represented by the image information stored in the storage circuit by a predetermined third party; and
an data access unit that causes the calculation unit to calculate a hash value of the additional image received by the document processing unit and updates the hash value stored in the storage circuit with the hash value of the additional image.

16. The information processing apparatus according to claim 4, wherein the processor is further configured to execute:
a document processing unit that receives additional image information representing an additional image obtained by adding information to the original image represented by the image information stored in the storage circuit by a predetermined third party; and
an data access unit that causes the calculation unit to calculate a hash value of the additional image received by the document processing unit and updates the hash value stored in the storage circuit with the hash value of the additional image.

17. The information processing apparatus according to claim 5, wherein the processor is further configured to execute:
document processing unit that receives additional image information representing an additional image obtained by adding information to the original image represented by the image information stored in the storage circuit by a predetermined third party; and
an data access unit that causes the calculation unit to calculate a hash value of the additional image received by the document processing unit and updates the hash value stored in the storage circuit with the hash value of the additional image.

18. The information processing apparatus according to claim 6, wherein the processor is further configured to execute:
a document processing unit that receives additional image information representing an additional image obtained by adding information to the original image represented by the image information stored in the storage circuit by a predetermined third party; and
an data access unit that causes the calculation unit to calculate a hash value of the additional image received by the document processing unit and updates the hash value stored in the storage circuit with the hash value of the additional image.

19. An information processing system comprising:
the information processing apparatus according to claim 1; and
an image generation apparatus that generates image information as the electronic information by reading an image.

20. A non-transitory computer readable medium storing an information processing program for causing a computer to function as the information processing apparatus according to claim 1.
